(19) United States
(12) Patent Application Publication
(10) Pub. No.: US 2026/0066413 A1
(43) Pub. Date: Mar. 5, 2026

(54) SECONDARY BATTERY

(71) Applicant: SAMSUNG SDI CO., LTD., Yongin-si (KR)

(72) Inventor: Dae-Sup KIM, Yongin-si (KR)

(21) Appl. No.: 19/019,780

(22) Filed: Jan. 14, 2025

(30) Foreign Application Priority Data
Aug. 28, 2024 (KR) 10-2024-0115950

(51) Int. Cl. H01M 50/193; H01M 50/109; H01M 50/153; H01M 50/171; H01M 50/474; H01M 50/533; H01M 50/559

(52) U.S. Cl. CPC H01M 50/193; H01M 50/109; H01M 50/153; H01M 50/171; H01M 50/474; H01M 50/533; H01M 50/559

(57) ABSTRACT

A secondary battery includes an electrode assembly including a first electrode, a separator, and a second electrode, a case assembly having one opened side, the case assembly accommodating the electrode assembly therein, and a cover portion screwed to the opened side of the case assembly. The case assembly of the secondary battery includes a case having one opened side and another side opposite the one opened side with a through hole therein, a terminal plate on an outer circumferential surface of the case, the terminal plate comprising a protrusion inserted into the through hole, an outer insulator between the case and the terminal plate, the outer insulator electrically insulating between the case and the terminal plate, and an inner insulator on an inner circumferential surface of the case, the inner insulator electrically insulating between the case and the electrode assembly.

### CROSS-REFERENCE TO RELATED APPLICATION

The present application claims priority to and the benefit of Korean Application No. 10-2024-0115950, filed on Aug. 28, 2024, in the Korean Intellectual Property Office, the entire disclosure of which is incorporated by reference herein.

### BACKGROUND

### 1. Field

Embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including an electrode assembly including a first electrode, a separator, and a second electrode, a case assembly having one opened side, the case assembly accommodating the electrode assembly therein, and a cover portion screwed to the opened side of the case assembly.

The case assembly may include a case having one opened side and another side opposite the one opened side with a through hole formed therein, a terminal plate on an outer circumferential surface of the case, the terminal plate including a protrusion inserted into the through hole, an outer insulator between the case and the terminal plate, the outer insulator electrically insulating between the case and the terminal plate, and an inner insulator on an inner circumferential surface of the case, the inner insulator electrically insulating between the case and the electrode assembly.

A first uncoated portion may be on one end of the first electrode in a length direction, a first lead tab extending from the first uncoated portion may protrude toward one side of the separator, resulting in a first lead tab protrusion, and the first lead tab may be joined to the first lead tab protrusion to electrically connect the first electrode and the terminal plate.

A second uncoated portion may be along the length direction at an end of the second electrode in a width direction, and the second uncoated portion may protrude from another side of the separator, the second uncoated portion being in contact with the cover portion to electrically connect the second electrode and the cover portion.

The cover portion may include a thread screwed to the electrode assembly, and an adhesive layer coated on the thread.

The adhesive layer may include a polymer-based adhesive including at least one of maleic anhydride polymerized polypropylene (MAPP) and polypropylene (PP).

The case may include a first thread on an inner circumferential surface of the one opened end, and the cover portion may have a disc shape, the cover portion including a second thread on an outer circumferential surface and joined to the first thread.

The cover portion may further include a latch groove recessed inward from the outer circumferential surface.

The cover portion may further include a pressurizing protrusion that protrudes from the inner circumferential surface and comes into contact with the electrode assembly.

The case may include a first thread on an outer circumferential surface of the one opened end, and the cover portion may include a cover portion plate configured to seal the one opened side of the case, and a joining portion protruding in an axial direction of the case along a circumference of the cover portion plate, the joining portion having a second thread on an inner circumferential surface, the second thread joined to the first thread.

The cover portion plate may include a latch groove recessed inward from the outer circumferential surface.

The cover portion plate may include a pressurizing protrusion that protrudes from the inner circumferential surface and comes into contact with the electrode assembly.

The case assembly may further include a current collector between the protrusion and the electrode assembly, the current collector electrically connecting the first electrode and the terminal plate.

The first electrode may include a first uncoated portion along the length direction at one end of a width direction, and the first uncoated portion may protrude from one side of the separator and may be electrically connected to and in contact with the current collector.

The current collector may include a current collector plate having a disc shape with a perforated center, the current collector being electrically connected to and in contact with the first uncoated portion, and an elastic joining portion extending from the center of the current collector plate, the elastic joining portion protruding in an axial direction of the case, the elastic joining portion being joined to the protrusion to electrically connect the current collector plate and the terminal plate.

The elastic joining portion may be elastically compressed if the electrode assembly is accommodated in the case, the elastic joining portion applying an elastic force so that the current collector plate is in contact with the first uncoated portion.

The second electrode may include a second uncoated portion along the length direction at the other end of a width direction, and the second uncoated portion may protrude from the other side of the separator and may be electrically connected to the cover portion in contact with the cover portion.

The case assembly may further include an insulating portion on the inner circumferential surface of the case, the case assembly electrically insulating between the case and the electrode assembly.

The secondary battery may further include an insulating sheet between the first lead tab and the electrode assembly, the insulating sheet electrically insulating between the first lead tab and the electrode assembly.

The insulating sheet may be made of an elastic material, the insulating sheet being elastically compressed in a case where the electrode assembly is accommodated in the case, and the electrode assembly may apply an elastic force so that the second uncoated portion is in contact with the cover portion.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 illustrates a cross-sectional view showing an example of a secondary battery according to one or more embodiments of the present disclosure;

FIG. 2 illustrates an exploded cross-sectional view showing an example of the secondary battery according to one or more embodiments of the present disclosure;

FIG. 3 illustrates an exploded cross-sectional view showing an example of a case assembly in the secondary battery according to one or more embodiments of the present disclosure;

FIG. 4 illustrates a plan view showing an example of an electrode assembly in the secondary battery according to one or more embodiments of the present disclosure;

FIG. 5 illustrates a cross-sectional view showing an example in which an insulation sheet is further provided in a secondary battery according to one or more embodiments of the present disclosure;

FIGS. 6 to 8 illustrate partial cross-sectional views showing an example of a cover portion in a secondary battery according to one or more embodiments of the present disclosure;

FIG. 9 illustrates a cross-sectional view showing an example in which a cover portion of another embodiment is applied to a secondary battery according to one or more embodiments of the present disclosure;

FIG. 10 illustrates an exploded cross-sectional view showing an example in which a cover portion of another embodiment is applied to a secondary battery according to one or more embodiments of the present disclosure;

FIGS. 11 and 12 illustrate partial cross-sectional views showing an example of a cover portion of a secondary battery according to one or more embodiments of the present disclosure;

FIG. 13 illustrates a cross-sectional view showing an example of a secondary battery according to one or more other embodiments of the present disclosure;

FIG. 14 illustrates an exploded cross-sectional view showing an example of the secondary battery according to one or more other embodiments of the present disclosure;

FIG. 15 illustrates a cross-sectional view showing an example of an electrode assembly of a secondary battery according to one or more other embodiments of the present disclosure; and

FIG. 16 illustrates a cross-sectional view showing an example in which a cover portion of another embodiment is applied to a secondary battery according to one or more other embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

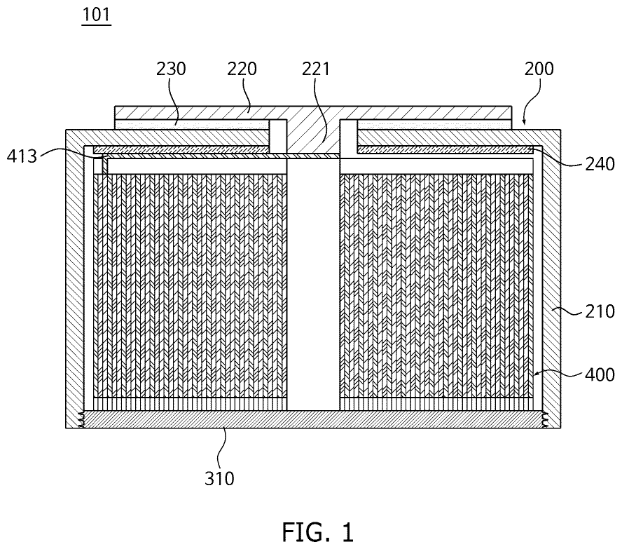

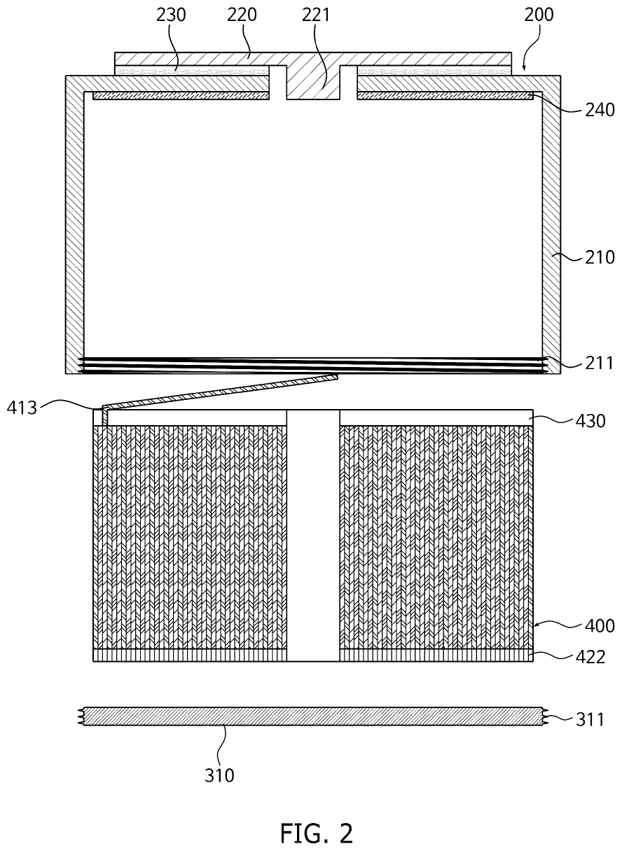

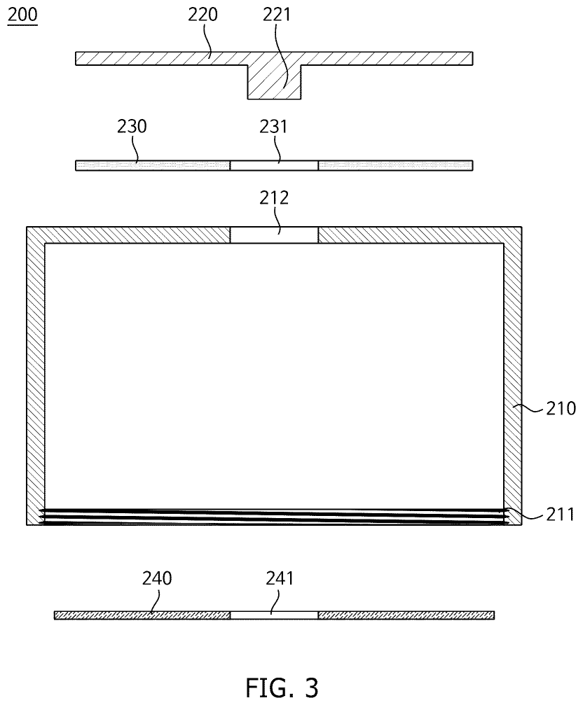

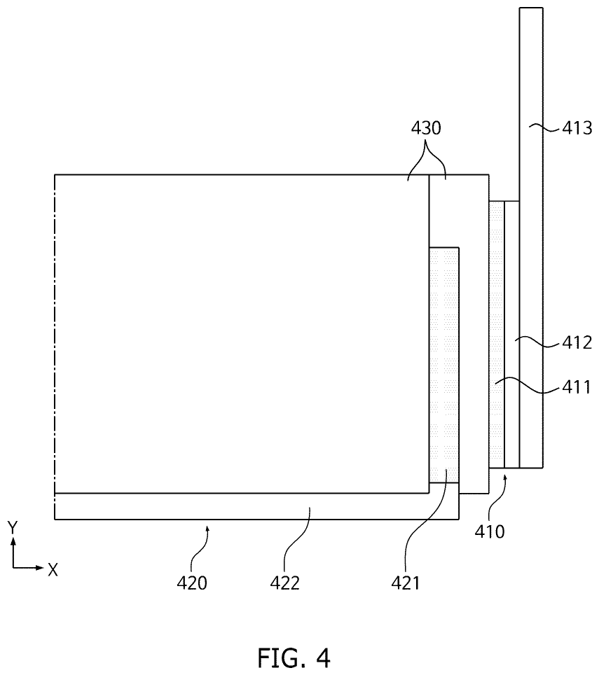

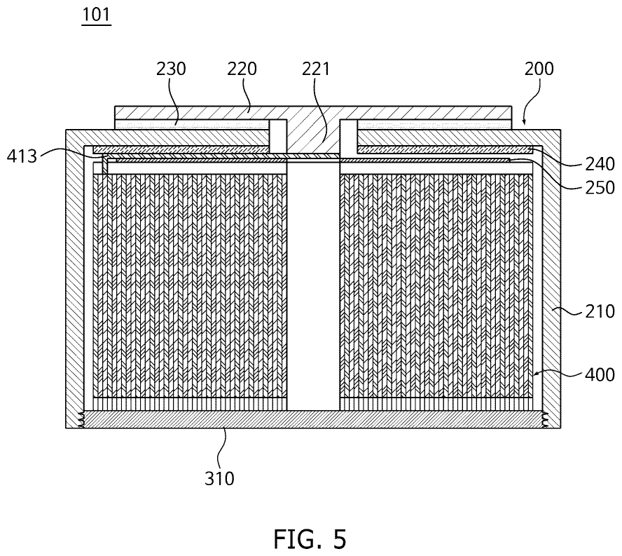

FIG. 1 illustrates a cross-sectional view showing an example of a secondary battery according to some embodiments of the present disclosure, and FIG. 2 illustrates an exploded cross-sectional view showing an example of the secondary battery according to some embodiments of the present disclosure. FIG. 3 illustrates an exploded cross-sectional view showing an example of a case assembly in the secondary battery according to some embodiments of the present disclosure, and FIG. 4 illustrates a plan view showing an example of an electrode assembly in the secondary battery according to some embodiments of the present disclosure. FIG. 5 illustrates a cross-sectional view showing an example in which an insulation sheet is further provided in a secondary battery according to some embodiments of the present disclosure.

Referring to FIGS. 1 to 4, a secondary battery 101 according to one or more embodiments of the present disclosure may include an electrode assembly 400, a case assembly 200 having one opened side and accommodating the electrode assembly 400, and a cover portion 310 screwed to the opened side (bottom side in the orientation shown) of the case assembly 200. The electrode assembly 400 may include a first electrode 410, a separator 430, and a second electrode 420.

The case assembly 200 may include a case 210 having one opened side and a through hole 212 formed on the other side thereof (top side in the orientation shown), a terminal plate 220 disposed on the outer side of the case 210 and including a protrusion 221 inserted into a through hole 212, an outer insulator 230 connecting between the case 210 and the terminal plate 220 and electrically insulating between the case 210 and the terminal plate 220, and an inner insulator 240 disposed on the inner side of the case 210 (at the top of the case 210 in the orientation shown) and electrically insulating between the case 210 and the electrode assembly 400.

In this structure, a first lead tab 413 of the first electrode 410 may be joined to the protrusion 221 of the terminal plate 220, and the cover portion 310 with which a second uncoated portion 422 of the second electrode 420 comes into contact may be joined to the case 210, so that the terminal plate 220 may be configured to function as a positive electrode and the case 210 may be configured to function as a negative electrode. Conversely, the terminal plate 220 may be configured to function as a negative electrode and the case 210 may be configured to function as a positive electrode.

The case 210 may be formed to have an opening on one surface and a hollow interior to accommodate the electrode assembly 400 therein. The through hole 212 may be formed on the other surface of the case 210, and the protrusion 221 of the terminal plate 220 may be inserted into the through hole 212. The diameter of the through hole 212 may be formed to be greater than the diameter of the protrusion 221 so as not to come into contact with the protrusion 221. The case 210 may be formed of a conductive metal, such as aluminum, an aluminum alloy, or nickel-plated steel. In some embodiments, the case 210 may be formed of steel use stainless (SUS).

In one or more embodiments, the case 210 may include a first thread 211 formed on the inner circumferential surface of the opened end. The cover portion 310 may be screwed to the first thread 211. The cover portion 310 may be formed in a disc shape, and a second thread 311 joined to the first thread 211 may be formed on the outer circumferential surface. The cover portion 310 may be formed of a conductive metal, such as aluminum, an aluminum alloy, or nickel-plated steel. In some embodiments, the cover portion 310 may be formed of steel use stainless (SUS). Therefore, in a case where the cover portion 310 is joined to the case 210, the cover portion 310 and the case 210 may have the same polarity. In some embodiments, in a case where the second electrode 420 is a negative electrode, the second uncoated portion 422 of the second electrode 420 is in contact with the cover portion 310 and the cover portion 310 is joined to the case 210, so that the cover portion 310 and the case 210 may function as a negative electrode. Conversely, in a case where the second electrode 420 is a negative electrode, the cover portion 310 and the case 210 may function as a positive electrode.

The terminal plate 220 may be formed in a disc shape having a smaller diameter than the case 210, and the protrusion 221 may be formed at the center so as to be inserted into the through hole 212 of the case 210. The protrusion 221 may be formed to protrude inward from the case 210 while being inserted into the through hole 212. The protrusion 221 may be configured to be joined to the first lead tab 413. In some embodiments, the shape of the terminal plate 220 may be formed in various shapes corresponding to the shape of the case 210.

The outer insulator 230 may be disposed between the case 210 and the terminal plate 220 to electrically insulate between the case 210 and the terminal plate 220. The case 210 and the terminal plate 220 are formed of a conductive metal material and are electrically connected to the negative electrode, which is the cover portion 310, and the positive electrode, which is the first lead tab 413, respectively, so that the outer insulator 230 may insulate between the case 210 and the terminal plate 220 to prevent a short circuit from occurring. In some embodiments, the outer insulator 230 may be formed of resin such as polypropylene (PP) or polyethylene (PE).

The outer insulator 230 may be formed in a disc shape with an insertion hole 231 formed in the center, similar to the case 210. Accordingly, the protrusion 221 of the terminal plate 220 may be disposed to pass through the insertion hole 231 of the outer insulator 230 and the through hole 212 of the case 210, so that the first lead tab 413 is joined to the protrusion 221. The outer diameter of the outer insulator 230 may be formed to be equal to, similar to, or greater than the outer diameter of the terminal plate 220. The case 210 may be formed to have a larger outer diameter than the outer insulator 230 and the terminal plate 220. The diameter of the insertion hole 231 of the outer insulator 230 may be formed to have be equal to or similar to the diameter of the through hole 212 of the case 210.

The outer insulator 230 may be joined to the case 210 and the terminal plate 220 by a heat-melting method of heating and pressurizing the case 210 and the terminal plate 220 while being disposed between the case 210 and the terminal plate 220. The method of joining between the outer insulator 230, the case 210, and the terminal plate 220, but the joining may be done in other ways, such as an adhesive layer may be formed on at least one side surface of the insulator 230 so that the insulator 230 and the case 210 and/or the terminal plate 220 may be joined by an adhesive method.

The inner insulator 240 may be disposed between the case 210 and the first lead tab 413 to electrically insulate between the case 210 and the first lead tab 413. The case 210 and the first lead tab 413 are formed of a conductive metal material, the case 210 is electrically connected to the negative electrode, which is the cover portion 310, and the first lead tab 413 is electrically connected to the positive electrode. Therefore, the inner insulator 240 may insulate between the case 210 and the first lead tab 413 to prevent a short circuit from occurring. In some embodiments, the inner insulator 240 may be formed of resin such as polypropylene (PP) or polyethylene (PE).

The inner insulator 240 may be formed in a disc shape with an insertion hole 241 formed in the center, similar to the case 210. Accordingly, the protrusion 221 of the terminal plate 220 may be disposed to pass through the insertion hole 241 of the inner insulator 240 and the through hole 212 of the case 210, so that the first lead tab 413 is joined to the protrusion 221.

The diameter of the insertion hole 241 of the inner insulator 240 may be formed to have be equal to or similar to the diameter of the through hole 212 of the case 210. The inner insulator 240 may be formed by coating an insulating material on the inner circumferential surface of the case 210 or by joining an insulating film by an adhesive method or the like.

The electrode assembly 400 may include the separator 430 and the first electrode 410 and the second electrode 420 positioned with the separator 430 interposed therebetween and may be wound in a jelly-roll shape. However, the shape may vary. In some embodiments, the electrode assembly 400 may be in a form in which a plurality of first electrodes, separators, and second electrodes are sequentially stacked.

The first electrode 410 may include a first substrate and a first active material layer 411 positioned on (e.g., applied to) the first substrate. The first lead tab 413 may extend outward from the first uncoated portion 412 where the first active material layer 411 of the first substrate is not positioned. The first uncoated portion 412 may be formed at one end of the first electrode 410 in the length direction X, and the first lead tab 413 may be connected to the first uncoated portion 412. The first lead tab 413 may protrude from one side of the separator 430 and may be joined to the protrusion 221 of the terminal plate 220 to electrically connect the first electrode 410 and the terminal plate 220.

The second electrode 420 may include a second substrate and a second active material layer 421 positioned on the second substrate. The second uncoated portion 422 in which the second active material layer 421 is not positioned in the second substrate may be formed. The second uncoated portion 422 may be formed along the length direction X at the other end of the second electrode 420 in the width direction Y. The second uncoated portion 422 may protrude to the other side while the electrode assembly 400 is wound in a jelly roll shape, and may come into contact with the cover portion 310 to electrically connect the second electrode 420 and the cover portion 310. In some embodiments, the second uncoated portion 422 may be formed as a plurality of tabs through a notching process. In this case, it may also be manufactured by bending and overlapping the plurality of tabs and then pressurizing the plurality of overlapping tabs using a tamping jig.

The first electrode 410 may act as a positive electrode. In such some embodiments, the first substrate may be made of, for example, an aluminum foil, and the first active material layer 411 may include, for example, a transition metal oxide. The second electrode 420 may act as a negative electrode. In such some embodiments, the second substrate may be made of, for example, a copper foil or a nickel foil, and the second active material layer 421 may include graphite, for example. In some embodiments, conversely, the first electrode 410 may function as a negative electrode and the second electrode 420 may function as a positive electrode.

The separator 430 prevents a short circuit between the first electrode 410 and the second electrode 420 while allowing movement of lithium ions therebetween. The separator 430 may be made of, for example, a polyethylene film, a polypropylene film, a polyethylene-polypropylene film, or the like.

The secondary battery 101 according to some embodiments of the present disclosure may be assembled by accommodating the electrode assembly 400 in the case 210, joining the first lead tab 413 to the protrusion 221 of the terminal plate 220, and then screwing the cover portion 310 to the case 210. After the first lead tab 413 is welded to the protrusion 221, the electrode assembly 400 may be accommodated in the case 210. In some embodiments, after the electrode assembly 400 is accommodated in the case 210, a welding rod may be inserted into the perforated center of the electrode assembly 400 to weld the first lead tab 413 to the protrusion 221.

With this configuration, because the first lead tab 413 electrically connected to the first electrode 410 is joined to the protrusion 221, the terminal plate 220 may have the same polarity as the first electrode 410. Because the second uncoated portion 422 of the second electrode 420 is electrically connected in contact with the cover portion 310 and the cover portion 310 is screwed to the case 210, the case 210 may have the same polarity as the second electrode 420.

Referring to FIG. 5, an insulating sheet 250 may be disposed between the first lead tab 413 and the electrode assembly 400 to electrically insulate between the first lead tab 413 and the electrode assembly 400. In some embodiments, the insulating sheet 250 may be formed of resin such as polypropylene (PP) or polyethylene (PE).

In one or more other embodiments, the insulating sheet 250 may be formed of an elastic material while having electrical insulating performance. In a case where the electrode assembly 400 is accommodated in the case 210 and the cover portion 310 is screwed to the case 210, the insulating sheet 250 may be elastically compressed. Because the elastically compressed insulating sheet 250 applies elastic force so that the electrode assembly 400 comes into close contact (e.g., direct contact) with the cover portion 310, the second uncoated portion 422 (see FIG. 4) may come into closer contact with the cover portion 310 and stably maintain an electrically connected state.

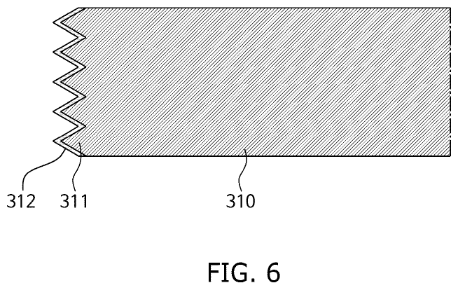

FIGS. 6 to 8 illustrate partial cross-sectional views showing an example of a cover portion in a secondary battery according to some embodiments of the present disclosure.

The cover portion 310 may be formed in a disc shape, and the second thread 311 that is screwed to the first thread formed in the case 210 may be formed along the outer circumferential surface. Accordingly, the cover portion 310 may be screwed to the opened side of the case 210 without separate welding.

To improve the bonding strength between the cover portion 310 and the case 210, an adhesive layer 312 may be coated on the second thread 311 of the cover portion 310. In some embodiments, the adhesive layer 312 may be coated on the first thread 211 of the case 210, or may be coated on both the first thread 211 and the second thread 311.

For example, the adhesive layer 312 may be formed by applying, to the thread, a polymer-based adhesive including at least one of maleic anhydride grafted polypropylene (MAPP) and polypropylene (PP). In some embodiments, the material of the adhesive layer 312 may be composed of any material as long as the material may seal the space between the case 210 and the cover portion 310 while improving adhesive strength and/or conductivity. In another example, the adhesive layer 312 may be formed by applying a conductive adhesive, such as an isotropic conductive adhesive, an anisotropic conductive adhesive, etc., to the thread.

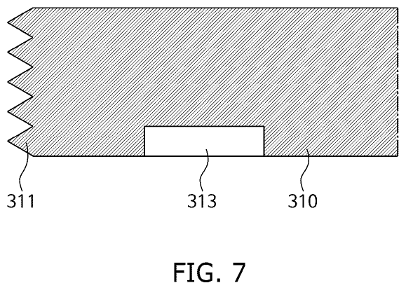

Referring to FIG. 7, the cover portion 310 may further include a latch groove 313 recessed inward from the outer circumferential surface. In order to screw the cover portion 310 to the case, the cover portion 310 has to be rotated. In order to more easily rotate the cover portion 310 having a disc shape, the latch groove 313 may be formed on the outer circumferential surface of the cover portion 310. With this configuration, a user's finger, a tool, or the like may be inserted into the latch groove 313 and the cover portion 310 may be rotated to screw the cover portion 310 to the case with greater force.

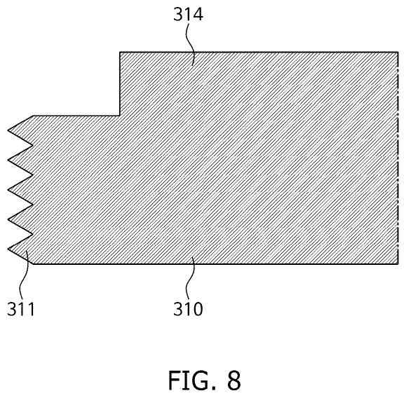

Referring to FIG. 8, the cover portion 310 may further include a pressurizing protrusion 314 that protrudes from the inner circumferential surface and comes into close contact with the electrode assembly. After the electrode assembly is accommodated in the case and the cover portion 310 is screwed to the case, the pressurizing protrusion 314 may pressurize the electrode assembly. Accordingly, the second uncoated portion of the electrode assembly may be brought into closer contact with the pressure protrusion 314 of the cover portion 310 and stably maintained in an electrically connected state.

In some embodiments, the cover portion 310 may have the latch groove 313 formed on the outer circumferential surface and the pressurizing protrusion 314 formed on the inner circumferential surface. In some embodiments, the adhesive layer 312 may be applied to the second thread 311 of the cover portion 310.

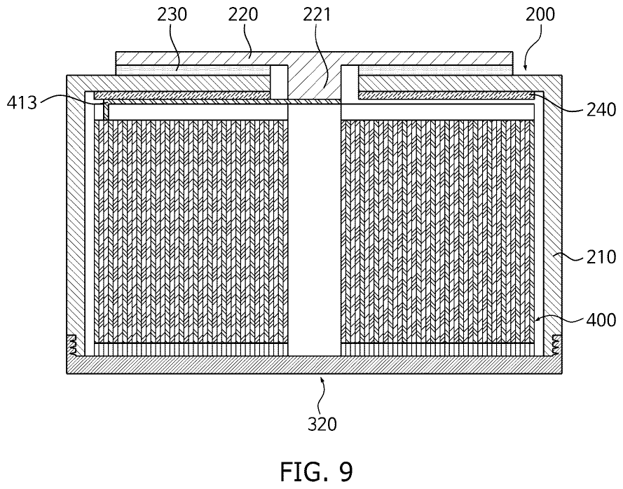

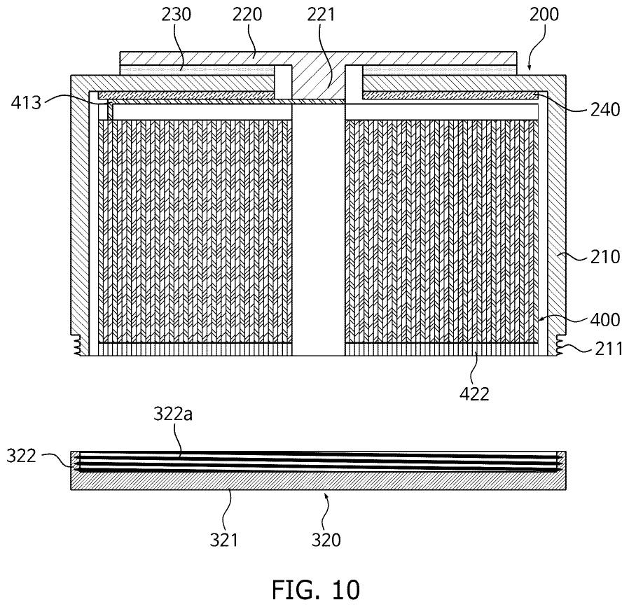

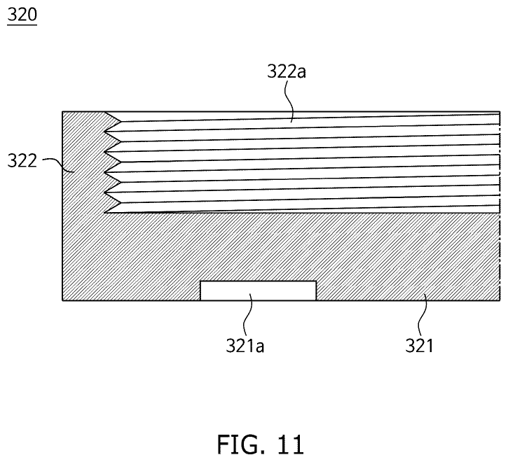

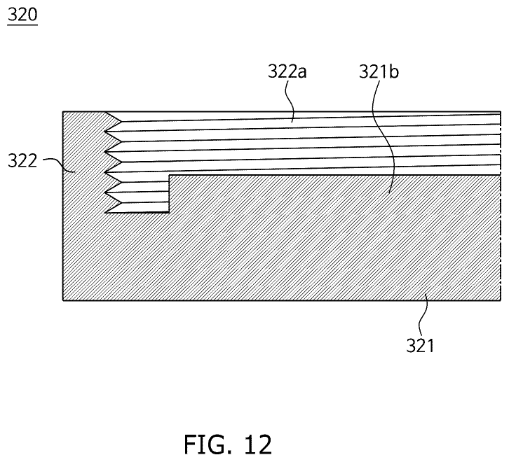

FIG. 9 illustrates a cross-sectional view showing an example in which a cover portion of another embodiment is applied to a secondary battery according to some embodiments of the present disclosure, and FIG. 10 illustrates an exploded cross-sectional view showing an example in which a cover portion of another embodiment is applied to a secondary battery according to some embodiments of the present disclosure. FIGS. 11 and 12 illustrate partial cross-sectional views showing an example of a cover portion of another embodiment in a secondary battery according to some embodiments of the present disclosure.

Referring to FIGS. 9 to 12, a cover portion 320 of one or more other embodiments may include a cover portion plate 321 that seals one opened side of a case 210, and a joining portion 322 that protrudes in the axial direction of the case 210 along the circumference of the cover portion plate 321 and has a second thread 322a formed on an inner circumferential surface that is joined to a first thread 211. At this time, the case 210 may have the first thread 211 formed on the outer circumferential surface of the opened end.

The cover portion 320 may be screwed in a form that surrounds one end of the case 210. Accordingly, the cover portion 320 may be rotated while holding the outer side of the cover portion 320 with an appropriate tool or a worker's hand, so that the cover portion 320 may be more easily joined to the case 210.

In one or more embodiments, an adhesive layer may be coated on the second thread 322a of the cover portion 320 to improve the bonding strength between the cover portion 320 and the case 210. In some embodiments, the adhesive layer may be coated on the first thread 211 of the case 210, or may be coated on both the first thread 211 and the second thread 322a.

For example, the adhesive layer may be formed by applying, to the thread, a polymer-based adhesive including at least one of maleic anhydride grafted polypropylene (MAPP) and polypropylene (PP). In some embodiments, the material of the adhesive layer may be composed of any material as long as the material may seal the space between the case 210 and the cover portion 320 while improving adhesive strength and/or conductivity. In another example, the adhesive layer 312 may be formed by applying a conductive adhesive, such as an isotropic conductive adhesive, an anisotropic conductive adhesive, etc., to the thread.

Referring to FIG. 11, the cover portion plate 321 may further include a latch groove 321a recessed inward from the outer circumferential surface. In order to screw the cover portion 320 to the case, the cover portion plate 321 has to be rotated. In order to more easily rotate the cover portion plate 321 having a disc shape, the latch groove 321a may be formed on the outer circumferential surface of the cover portion plate 321. With this configuration, a user's finger, a tool, or the like may be inserted into the latch groove 321a and the cover portion plate 321 may be rotated to screw the cover portion 320 to the case with greater force.

Referring to FIG. 12, the cover portion plate 321 may further include a pressurizing protrusion 321b that protrudes from the inner circumferential surface and comes into close contact with the electrode assembly. After the electrode assembly is accommodated in the case and the cover portion plate 321 is screwed to the case, the pressurizing protrusion 321b may pressurize the electrode assembly. Accordingly, the second uncoated portion of the electrode assembly may be brought into closer contact with the pressurizing protrusion 321b of the cover portion 321 and stably maintained in an electrically connected state.

In some embodiments, the cover portion plate 321 may have the latch groove 321a formed on the outer circumferential surface and the pressurizing protrusion 321b formed on the inner circumferential surface. In some embodiments, an adhesive layer may be applied to the second thread 322a formed on the inner circumferential surface of the joining portion 322.

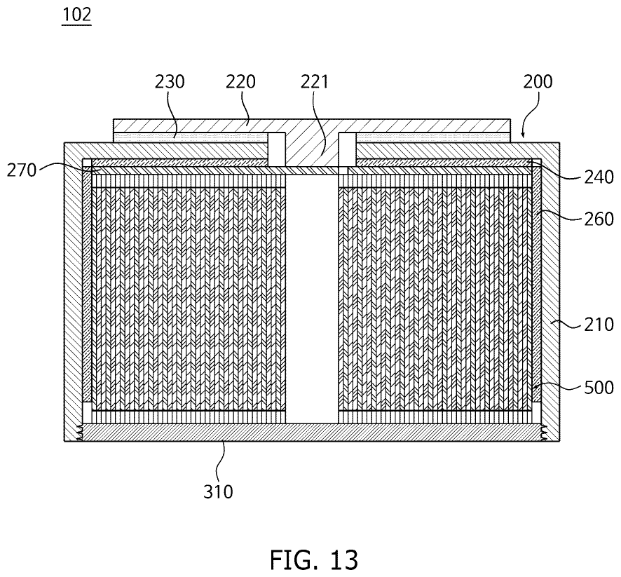

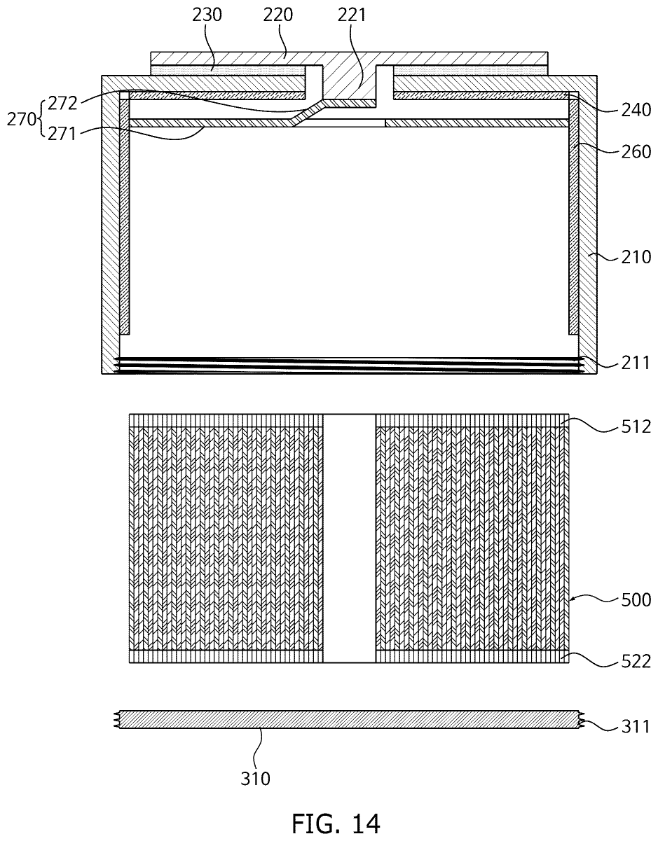

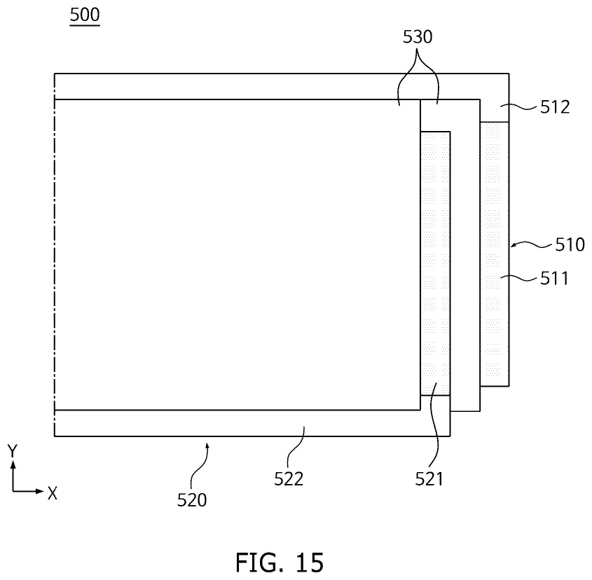

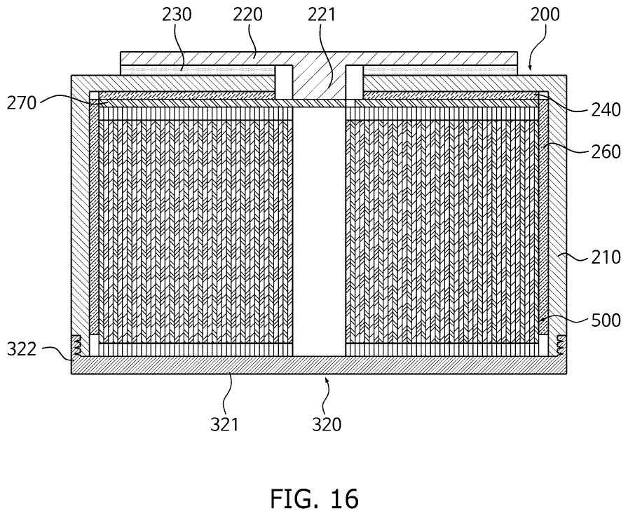

FIG. 13 illustrates a cross-sectional view showing an example of a secondary battery according to another embodiment of the present disclosure, and FIG. 14 illustrates an exploded cross-sectional view showing an example of the secondary battery according to another embodiment of the present disclosure. FIG. 15 illustrates a cross-sectional view showing an example of an electrode assembly of a secondary battery according to another embodiment of the present disclosure. FIG. 16 illustrates a cross-sectional view showing an example in which a cover portion of another embodiment is applied to a secondary battery according to another embodiment of the present disclosure.

Referring to FIGS. 13 to 16, a secondary battery 102 according to one or more other embodiments of the present disclosure may include an electrode assembly 500, a case assembly 200 having one opened side (at the bottom in the orientation shown in FIG. 13) and accommodating the electrode assembly 500 therein, and a cover portion 310 screwed to the opened side of the case assembly 200. The electrode assembly 500 may include a first electrode 510, a separator 530, and a second electrode 520.

The case assembly 200 may include a case 210 having one opened side and a through hole 212 formed on the other side thereof, a terminal plate 220 disposed on the outer side of the case 210 and including a protrusion 221 inserted into a through hole 212, an outer insulator 230 connecting between the case 210 and the terminal plate 220 and electrically insulating between the case 210 and the terminal plate 220, an inner insulator 240 disposed on the inner side of the case 210 and electrically insulating between the case 210 and the electrode assembly 400, and a current collector 270 disposed between the protrusion 221 and the electrode assembly 500 and electrically connecting the first electrode 510 and the terminal plate 220.

In this structure, the current collector 270 may be joined to the protrusion 221 of the terminal plate 220, the current collector 270 may be joined to the first uncoated portion 512 of the first electrode 510, and the cover portion 310 that comes into contact with the second uncoated portion 522 of the second electrode 520 may be joined to the case 210, so that the terminal plate 220 may be configured to function as a positive electrode and the case 210 may be configured to function as a negative electrode. In some embodiments, conversely, the terminal plate 220 may be configured to function as a negative electrode and the case 210 may be configured to function as a positive electrode.

In the case assembly 200, the case 210, the terminal plate 220, the outer insulator 230, and the inner insulator 240 are the same as the configurations described above with reference to FIG. 3, and thus, a detailed description thereof is omitted.

The current collector 270 may include a current collector plate 271 formed in a circular shape with a perforated center and electrically connected to and in contact with the first uncoated portion 512, and an elastic joining portion 272 that extends from the center of the current collector plate 271, protrudes in the axial direction of the case 210, is joined to the protrusion 221, and electrically connects the current collector plate 271 and the terminal plate 220. The elastic joining portion 272 may be electrically connected to the protrusion 221 by laser welding or the like.

In a case where the electrode assembly 500 is accommodated in the case 210, the elastic joining portion 272 may be pressurized against the first uncoated portion 512 and elastically compressed, and in a case where the cover portion 310 is joined to the case 210, the elastic joining portion 272 is elastically recovered to apply elastic force so that the current collector plate 271 is in close contact with the first uncoated portion 512. Accordingly, the current collector plate 271 may be more stably maintained in a state of being electrically connected to the first uncoated portion 512.

The case assembly 200 may further include an insulating portion 260 that is disposed on the inner circumferential surface of the case 210 and electrically insulates between the case 210 and the electrode assembly 500. The current collector plate 271 and the first uncoated portion 512 provided inside the case 210 may function as a different electrode from the case 210. Accordingly, the insulating portion 260 may be provided on the inner circumferential surface of the case 210 to electrically insulate between the current collector plate 271 and the first uncoated portion 512 from the case 210.

The electrode assembly 500 may include the separator 530 and the first electrode 510 and the second electrode 520 positioned with the separator 530 provided therebetween and may be wound in a jelly-roll shape. In some embodiments, the shape of the electrode assembly 500 is not limited thereto, and the electrode assembly may be in a form in which a plurality of first electrodes, separators, and second electrodes are sequentially stacked.

The first electrode 510 may include a first substrate and a first active material layer 511 positioned on the first substrate. The first uncoated portion 512 in which the first active material layer 511 is not positioned in the first substrate may be formed. The first uncoated portion 512 may be formed along the length direction X at one end of the second electrode 520 in the width direction Y. The first uncoated portion 512 may protrude to one side while the electrode assembly 500 is wound in a jelly roll shape, and may come into contact with the current collector plate 271 to electrically connect the first electrode 510 and the terminal plate 220. In some embodiments, the first uncoated portion 512 may be formed as a plurality of tabs through a notching process. In this case, it may also be manufactured by bending and overlapping the plurality of tabs and then pressurizing the plurality of overlapping tabs using a tamping jig.

The second electrode 520 may include a second substrate and a second active material layer 521 positioned on the second substrate. The second uncoated portion 522 in which the second active material layer 521 is not positioned in the second substrate may be formed. The second uncoated portion 522 may be formed along the length direction X at the other end of the second electrode 520 in the width direction Y. The second uncoated portion 522 may protrude to the other side while the electrode assembly 500 is wound in a jelly roll shape, and may come into contact with the cover portion 310 to electrically connect the second electrode 520 and the cover portion 310. In some embodiments, the second uncoated portion 522 may be formed as a plurality of tabs through a notching process. In this case, it may also be manufactured by bending and overlapping the plurality of tabs and then pressurizing the plurality of overlapping tabs using a tamping jig.

The first electrode 510 may act as a positive electrode. In such some embodiments, the first substrate may be made of, for example, an aluminum foil, and the first active material layer 511 may include, for example, a transition metal oxide. The second electrode 520 may act as a negative electrode. In such some embodiments, the second substrate may be made of, for example, a copper foil or a nickel foil, and the second active material layer 521 may include graphite, for example. In some embodiments, conversely, the first electrode 510 may function as a negative electrode and the second electrode 520 may function as a positive electrode.

The separator 530 prevents a short circuit between the first electrode 510 and the second electrode 520 while allowing movement of lithium ions therebetween. The separator 530 may be made of, for example, a polyethylene film, a polypropylene film, a polyethylene-polypropylene film, or the like.

The secondary battery 102 according to one or more embodiments of the present disclosure may be assembled by accommodating the electrode assembly 500 in the case 210 and then screwing the cover portion 310 to the case 210. After the cover portion 310 is screwed to the case 210, the electrode assembly 500 may be brought into close contact with the cover portion 310 by the elastic force of the elastic joining portion 272, the current collector plate 271 may be brought into close contact with the first uncoated portion 512, and the second uncoated portion 522 may be brought into close contact with the cover portion 310, thereby stably maintaining an electrically connected state.

With this configuration, the current collector 270 electrically connected to the first uncoated portion 512 of the first electrode 510 may be joined to the protrusion 221, so that the terminal plate 220 may have the same polarity as the first electrode 510. Because the second uncoated portion 522 of the second electrode 520 is electrically connected in contact with the cover portion 310 and the cover portion 310 is screwed to the case 210, the case 210 may have the same polarity as the second electrode 420.

Referring to FIG. 14, the cover portion 310 may be formed in a disc shape, and the second thread 311 that is screwed to the first thread 211 formed in the case 210 may be formed along the outer circumferential surface of the cover portion 310. Accordingly, the cover portion 310 may be screwed or connected to the opened side of the case 210 without separate welding.

As shown in FIG. 7, the cover portion 310 may further include a latch groove 313 recessed inward from the outer circumferential surface. In some embodiments, as shown in FIG. 8, the cover portion 310 may further include a pressurizing protrusion 314 that protrudes from the inner circumferential surface and comes into close contact with the electrode assembly. In some embodiments, the cover portion 310 may have the latch groove 313 formed on the outer circumferential surface and the pressurizing protrusion 314 formed on the inner circumferential surface. In some embodiments, the adhesive layer 312 may be applied to the second thread 311 of the cover portion 310.

Referring to FIG. 16, a cover portion 320 of one or more other embodiments may include a cover portion plate 321 that seals one opened side of a case 210, and a joining portion 322 that protrudes in the axial direction of the case 210 along the circumference of the cover portion plate 321 and has a second thread formed on an inner circumferential surface that is joined to a first thread. At this time, the case 210 may have the first thread formed on the outer circumferential surface of the opened end.

The cover portion 320 may be screwed in a form that surrounds one end of the case 210. Accordingly, the cover portion 320 may be rotated while holding the outer side of the cover portion 320 with a tool or a worker's hand, so that the cover portion 320 may be more easily joined to the case 210.

As shown in FIG. 11, the cover portion plate 321 may further include a latch groove 321a recessed inward from the outer circumferential surface. In some embodiments, as shown in FIG. 12, the cover portion plate 321 may further include a pressurizing protrusion 321b that protrudes from the inner circumferential surface and comes into close contact with the electrode assembly. In some embodiments, although not shown in the drawing, the cover portion plate 321 may have the latch groove 321a formed on the outer circumferential surface and the pressurizing protrusion 321b formed on the inner circumferential surface. In some embodiments, an adhesive layer may be applied to the second thread 322a formed on the inner circumferential surface of the joining portion 322.

A secondary battery accommodates an electrode assembly in a case, and a cap assembly is installed in an opening of the case, and then the cap assembly is welded to the case. In the case of welding, an insulation tape, etc. may melt due to welding heat, and thus, insulation performance may deteriorate.

According to some embodiments of the present disclosure, the cover portion may be joined to one opened side of the case of the secondary battery without welding to seal the case, thereby preventing a deterioration in insulation performance due to welding.

According to some embodiments of the present disclosure, because the cover portion may be joined to one opened side of the case of the secondary battery by screwing or adhesive method without welding to seal the case, the efficiency of the manufacturing process of the secondary battery may be increased.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

DESCRIPTION OF SOME REFERENCE SYMBOLS

| | |
|---|---|
| 101, 102: secondary battery | 200: case assembly |
| 210: case | 211: first thread |
| 220: terminal plate | 221: protrusion |
| 230: outer insulator | 240: inner insulator |
| 250: insulating sheet | 260: insulating portion |
| 270: current collector | 271: current collector plate |
| 272: elastic joining portion | 310, 320: cover portion |
| 311, 322a: second thread | 400, 500: electrode assembly |
| 410, 510: first electrode | 411, 511: first active material layer |
| 412, 512: first uncoated portion | 413: first lead tab |
| 420, 520: second electrode | 421, 521: second active material layer |
| 422, 522: second uncoated portion | 430, 530: separator |

What is claimed is:

1. A secondary battery, comprising:
an electrode assembly comprising a first electrode, a separator, and a second electrode;
a case assembly having one opened side, the case assembly accommodating the electrode assembly therein; and
a cover portion screwed to the opened side of the case assembly.

2. The secondary battery as claimed in claim 1, wherein the case assembly comprises:
a case having one opened side and another side opposite the one opened side with a through hole therein;
a terminal plate on an outer circumferential surface of the case, the terminal plate comprising a protrusion inserted into the through hole;
an outer insulator between the case and the terminal plate, the outer insulator electrically insulating between the case and the terminal plate; and
an inner insulator on an inner circumferential surface of the case, the inner insulator electrically insulating between the case and the electrode assembly.

3. The secondary battery as claimed in claim 2, wherein:
a first uncoated portion is on one end of the first electrode in a length direction,
a first lead tab extending from the first uncoated portion protrudes toward one side of the separator, resulting in a first lead tab protrusion, and
the first lead tab is joined to the first lead tab protrusion to electrically connect the first electrode and the terminal plate.

4. The secondary battery as claimed in claim 3, wherein:
a second uncoated portion is along the length direction at an end of the second electrode in a width direction, and
the second uncoated portion protrudes from another side of the separator, the second uncoated portion being in contact with the cover portion to electrically connect the second electrode and the cover portion.

5. The secondary battery as claimed in claim 4, further comprising an insulating sheet between the first lead tab and the electrode assembly, the insulating sheet electrically insulating between the first lead tab and the electrode assembly.

6. The secondary battery as claimed in claim 5, wherein:
the insulating sheet is made of an elastic material, the insulating sheet being elastically compressed in a case where the electrode assembly is accommodated in the case, and
the electrode assembly applies elastic force so that the second uncoated portion is in contact with the cover portion.

7. The secondary battery as claimed in claim 2, wherein:
the case comprises a first thread on an inner circumferential surface of the one opened side, and
the cover portion has a disc shape, the cover portion comprising a second thread on an outer circumferential surface and joined to the first thread.

8. The secondary battery as claimed in claim 7, wherein the cover portion further comprises a latch groove recessed inward from the outer circumferential surface.

9. The secondary battery as claimed in claim 7, wherein the cover portion further comprises a pressurizing protrusion that protrudes from the inner circumferential surface and comes into contact with the electrode assembly.

10. The secondary battery as claimed in claim 2, wherein:
the case comprises a first thread on an outer circumferential surface of the one opened side, and
the cover portion comprises:
a cover portion plate configured to seal the one opened side of the case; and
a joining portion protruding in an axial direction of the case along a circumference of the cover portion plate, the joining portion having a second thread on an inner circumferential surface, the second thread joined to the first thread.

11. The secondary battery as claimed in claim 10, wherein the cover portion plate comprises a latch groove recessed inward from the outer circumferential surface.

12. The secondary battery as claimed in claim 10, wherein the cover portion plate comprises a pressurizing protrusion that protrudes from the inner circumferential surface and comes into contact with the electrode assembly.

13. The secondary battery as claimed in claim 2, wherein the case assembly further comprises a current collector between the protrusion and the electrode assembly, the current collector electrically connecting the first electrode and the terminal plate.

14. The secondary battery as claimed in claim 13, wherein:
the first electrode comprises a first uncoated portion along a length direction at one end of a width direction, and
the first uncoated portion protrudes from one side of the separator and is electrically connected to and in contact with the current collector.

15. The secondary battery as claimed in claim 14, wherein the current collector comprises:
a current collector plate having a disc shape with a perforated center, the current collector being electrically connected to and in contact with the first uncoated portion; and
an elastic joining portion extending from the center of the current collector plate, the elastic joining portion protruding in an axial direction of the case, the elastic joining portion being joined to the protrusion to electrically connect the current collector plate and the terminal plate.

16. The secondary battery as claimed in claim 15, wherein the elastic joining portion is elastically compressed if the electrode assembly is accommodated in the case, the elastic joining portion applying an elastic force so that the current collector plate is in contact with the first uncoated portion.

17. The secondary battery as claimed in claim 14, wherein:
the second electrode comprises a second uncoated portion along the length direction at another end of a width direction, and
the second uncoated portion protrudes from another side of the separator and is electrically connected to the cover portion in contact with the cover portion.

18. The secondary battery as claimed in claim 2, wherein the case assembly further comprises an insulating portion on the inner circumferential surface of the case, the case assembly electrically insulating between the case and the electrode assembly.

19. The secondary battery as claimed in claim 1, wherein the cover portion comprises:
a thread screwed to the electrode assembly; and
an adhesive layer coated on the thread.

20. The secondary battery as claimed in claim 19, wherein the adhesive layer comprises a polymer-based adhesive including at least one of maleic anhydride polymerized polypropylene MAPP and polypropylene PP.
